(19) United States
(12) Patent Application Publication
(10) Pub. No.: US 2005/0288966 A1
(43) Pub. Date: Dec. 29, 2005

(54) SYSTEM AND METHOD FOR COLLECTING DIAGNOSIS AND PRESCRIPTION DRUG INFORMATION

(76) Inventor: Robert YOUNG, Bel Air, MD (US)

Correspondence Address: NOVAK DRUCE & QUIGG, LLP, 1300 EYE STREET NW, 400 EAST TOWER, WASHINGTON, DC, 20005, US

(21) Appl. No.: 10/905,315

(22) Filed: Dec. 27, 2004

Related U.S. Application Data
(60) Provisional application No. 60/532,173, filed on Dec. 24, 2003.

(51) Int. Cl. G06F 17/60

(52) U.S. Cl. 705/3

(57) ABSTRACT

A system for the capture, management or use of patient medical and prescription data is disclosed. In some illustrative embodiments, the system includes: a computer system including at least one server computer and at least one physician computer in communication with said at least one server over a network, such as the Internet; wherein said at least one server computer includes a database of drug side effects, interactions or contraindications, which are accessible via said at least one physician computer via a graphical user interface.

### CROSS-REFERENCE TO RELATED APPLICATIONS

The present application claims priority to provisional application No. 60/532,173, entitled SYSTEM AND METHOD FOR COLLECTING DIAGNOSIS AND PRESCRIPTION DRUG INFORMATION, filed on Dec. 24, 2004, naming Mr. Robert Young as the sole inventor, the entire disclosure of which is incorporated herein by reference as though recited herein in full.

### FIELD OF THE INVENTION

The preferred embodiments relate to systems used in the health care industry for medical billing and recording systems, more particularly to an improved method and system which captures diagnosis information, drug prescription and procedural information together.

### DESCRIPTION OF THE BACKGROUND

Current medical billing systems do not capture diagnosis information, prescription drug and procedural information. A major component of existing systems are encounter forms, which are completed after a physician has seen and evaluated a patient. Encounter forms typically used in physicians' offices include a patient's diagnosis information, but do not include the prescription drug and/or procedural information. This is the typical practice of capturing diagnosis information on the billing side. The benefits of having a system that captures diagnosis, drug prescription and procedural information has not previously been realized.

### SUMMARY OF THE INVENTION

The preferred embodiments provide a method and system for, among other things, collecting diagnosis, prescription drug and procedural information at a physician's office. Collecting diagnosis information, prescription drug and procedural information can provide many benefits to doctors, pharmaceutical companies, drug-store chains, and/or others. The information collected can be used for various statistical and/or other analyses.

In some embodiments, the present invention includes means to capture both diagnosis information and drug prescription information together. In particular, this information is particularly useful when collected on a large scale related to numerous patients. For example, this can provide statistical analysis, this can enable large drug companies to advertise their drugs for purposes based upon statistical determinations, and more.

In some embodiments, a doctor's office would be provided with a computer disk (such as, e.g., a CD or a DVD) containing software to download on their computer. Most doctor's offices will have simple scanners that can be used with some embodiments. The software on the doctor's machine will enable the doctor's office to capture both diagnosis information and drug information. Then, the software will, preferably, automatically send captured information to a central computer located remotely from the doctor's office. In some embodiments, this central computer could be managed by one or more of a large drug company, a pharmaceutical chain, such as in some non-limiting examples described herein Rite-Aid, or another central company. The software preferably creates a number of forms or at least one form. When a patient enters a doctor's office, they usually fill out an initial form identifying the reasons for their visit, etc. Upon evaluating and meeting with the patient, the doctor's office usually fills out what is commonly called an encounter form, or a CPT form. The CPT form typically includes only diagnosis information. The CPT form typically does not include drug prescription information. Apparently, diagnosis information is not captured on the “drug” side, but is typically captured on the “billing” side. The present invention will capture both drug and diagnosis information together in a manner not previously done. In some instances, an encounter form is also commonly referred to as the HICVA form.

In some embodiments, the computer generates an encounter form. Preferably, the form can be varied by the computer based upon a number of circumstances. For example, the computer preferably can modify the potential diagnoses to be checked off on the form based upon a number of factors such as: the time of year or season; the patient's gender; the patient's history; and/or other information. In addition, the encounter form could also be generated in part based upon information filled out by the patient on the initial form completed upon visiting the doctor's office. For example, a patient could fill in an initial form that is keyed into the system by a nurse or the like at the doctor's office which is used to generate the encounter form.

Among other things, the automatic scanning of the encounter form into the computer system can facilitate the doctor's offices handling of billing. In this regard, the information on the encounter form does not need to be typed into a computer to generate bills. On the other hand, the encounter form information can be scanned into the computer to automatically generate bills. In addition, doctors will benefit because the costs for the software can be very inexpensive. In some cases, the costs might even be subsidized by other companies such as large drug companies and/or pharmaceutical companies. In this regard, these other companies may subsidize this software because of the great benefits they get from the information returned to them related to the diagnosis and drug information, etc.

In some preferred embodiments, the information received at the central computer can be sold to other companies and/or access to such information can be given to other companies for a price. In this manner, the manager of this information can receive a great financial benefit. The discharging of this information should be in accordance with HIPPA privacy requirements in retaining patient confidentiality. In some instances, patients will be required to sign an agreement enabling them to dispense or disseminate certain information.

In some embodiments, the software on the physician's office computer can automatically in to a remote central computer, such as over the Internet or via a telephone line or via any other communication means. In other embodiments, the central computer can call in to receive the information from the physician's office computer. The manner of communication between the computers is not material. However, in some preferred embodiments, the physician's computer will automatically dial in to the remote computers. This can be relatively easily carried out because programming will be installed on the physician's computers. In addition, most physician's offices will already have internet access such that obtaining internet communications will be relatively simple.

In some instances, the diagnosis and drug information can be used to, for example, evaluate geographical issues related to drugs, determine unknown side effects of drugs, keep a clear record on a patient by patient basis of drugs actually given to that patient to enable doctors to avoid giving improper drugs to patients, and other benefits.

In some embodiments, the encounter form that is printed out will include spaces for the doctor to fill in the drug prescription. This can include, for example, blank spaces in which doctors can complete the form by filling out the prescription information or drug information. In other embodiments, this can include check boxes similar to those used in the diagnosis information section so that doctors can indicate drugs prescribed by merely checking boxes to ensure increased accuracy. In addition, the prescription section could also include and/or alternatively include places to fill in and/or check boxes or the like to fill in usage requirements for the particular drug such as the dose, the daily regimen for taking the drug, and the like. In some embodiments, the drug prescription filled in by the doctor on the form could be automatically determined based upon being scanned into the computer with the software determining the entered diagnosis based upon software reading of the form. In other embodiments, the form could be scanned in, but the drug prescription might be keyed in to the form by a user.

The above and/or other aspects, features and advantages of the invention will be further appreciated based on the following description in conjunction with the included drawing and attachments.

### BRIEF DESCRIPTION OF THE DRAWINGS

The present invention will be described in further detail with respect to preferred embodiments of the invention as illustrated in the accompanying figures, which are given by way of example and not limitation, and in which:

FIG. 1 shows a general flowchart of an illustrative overall system;

FIGS. 2-3 show non-limiting examples of encounter forms that can be used with the system in some illustrative embodiments; and

FIGS. 4-30 outline some exemplary and non-limiting features of some preferred embodiments.

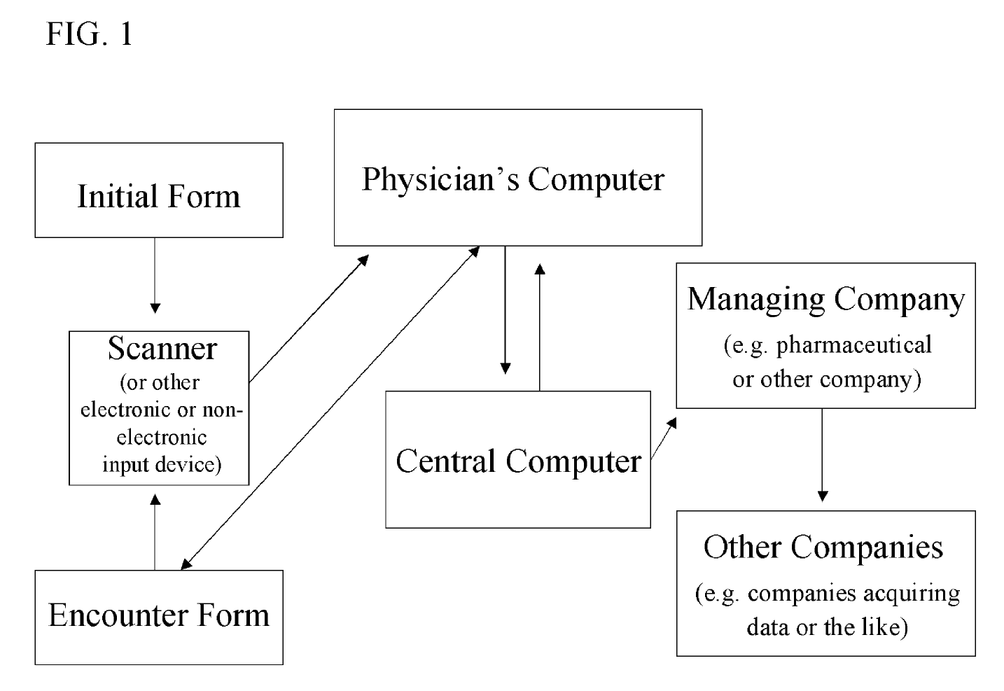

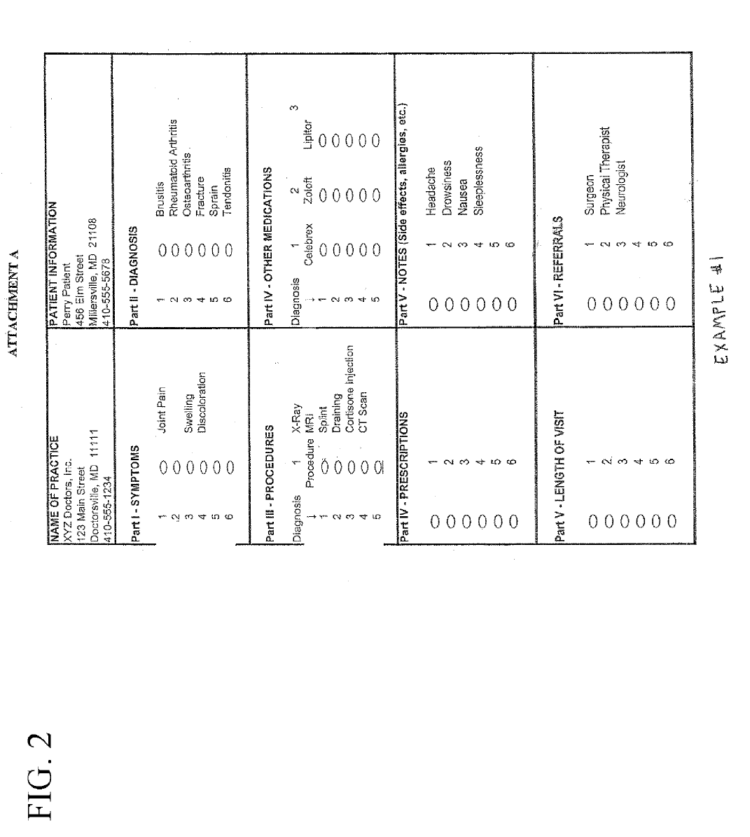

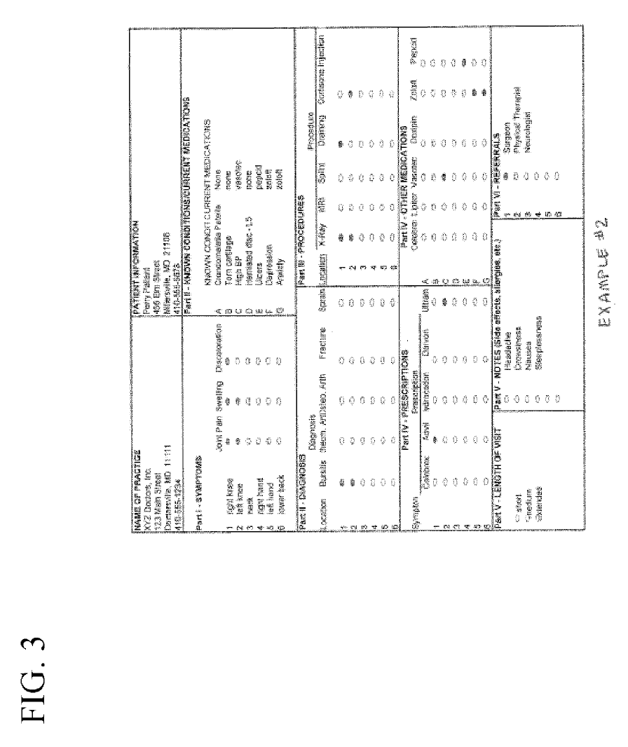

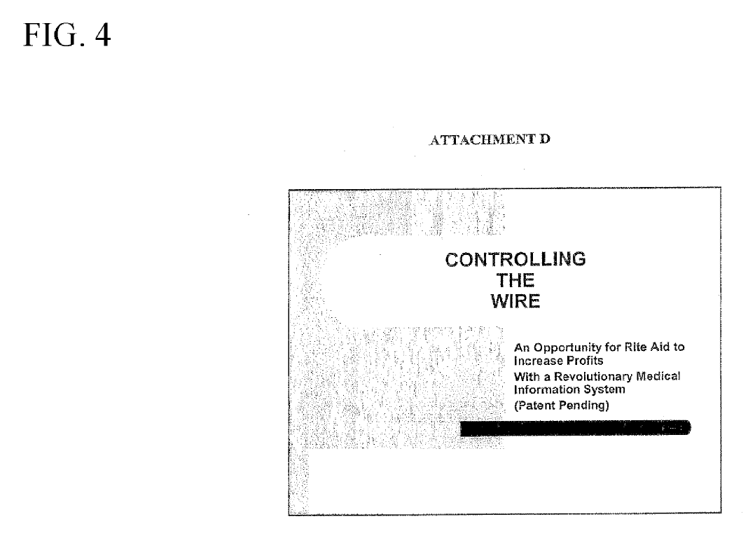

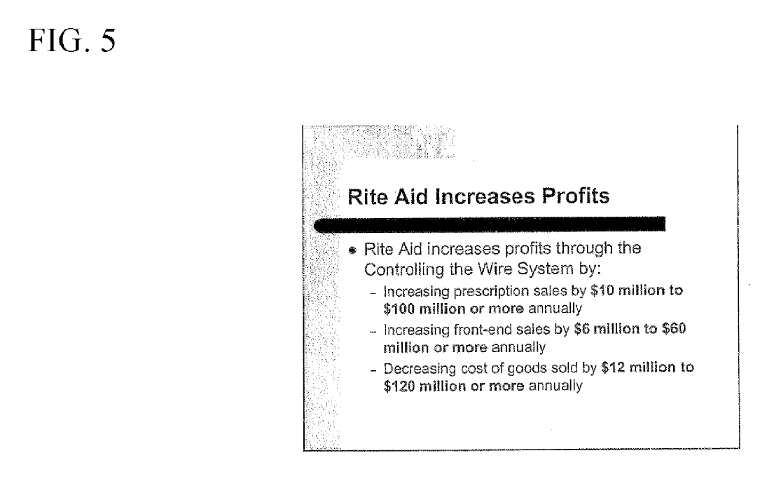

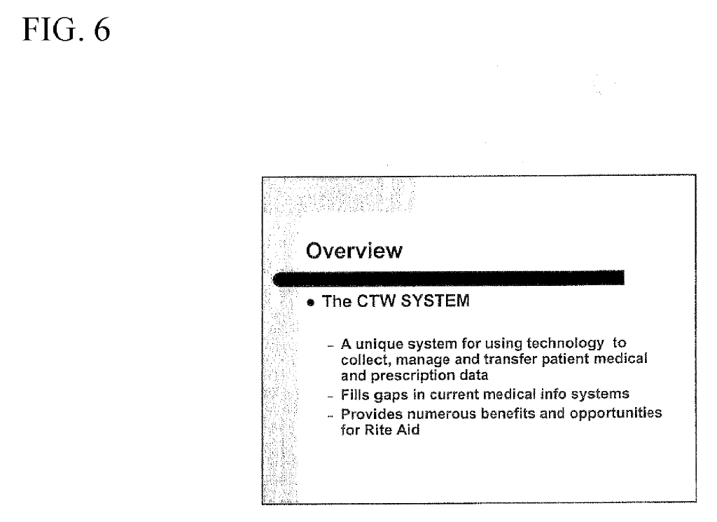

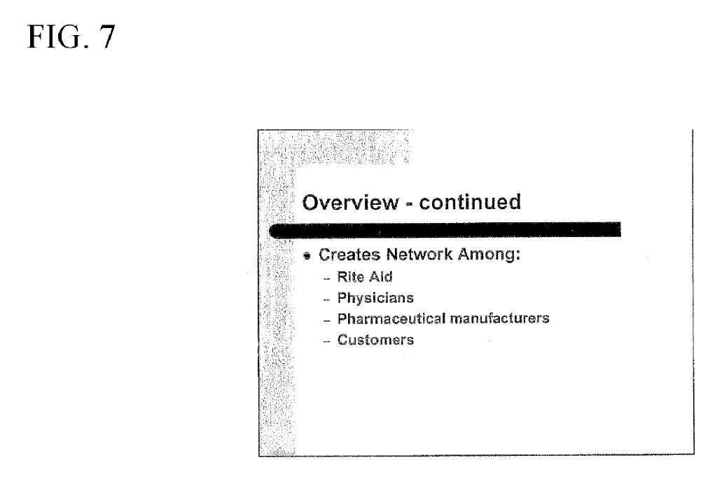

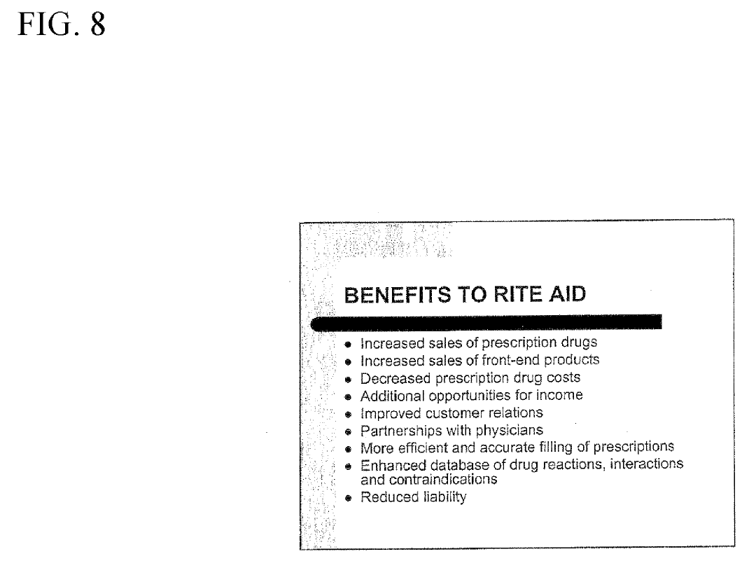

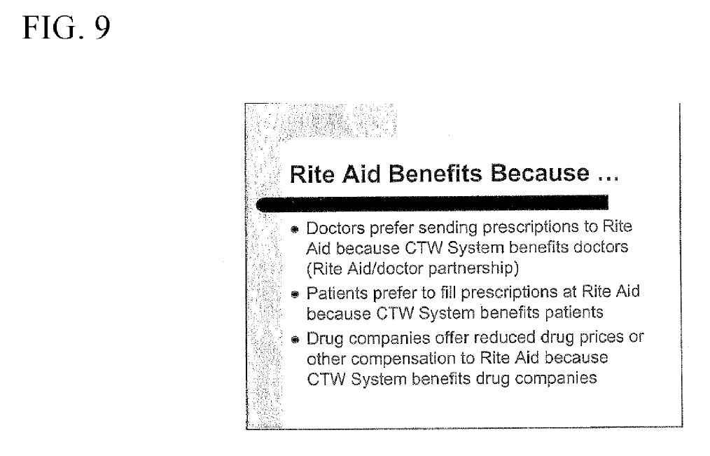

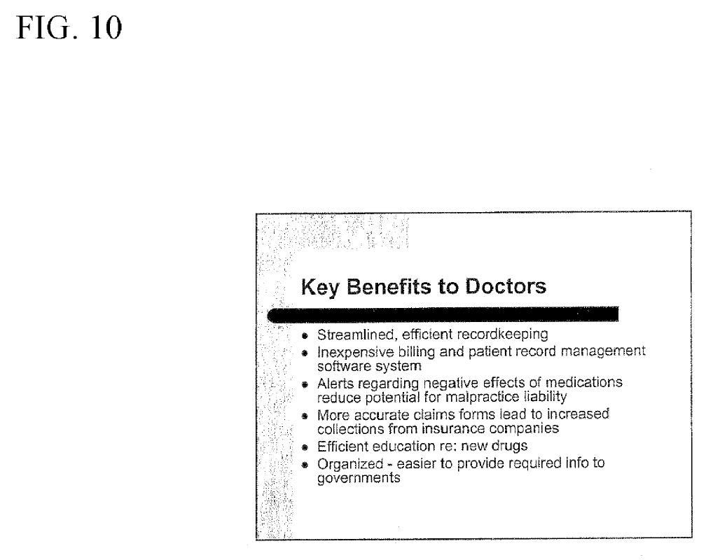

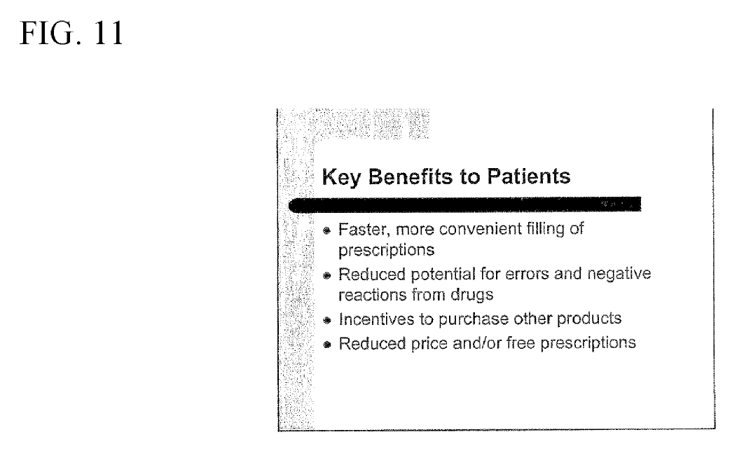

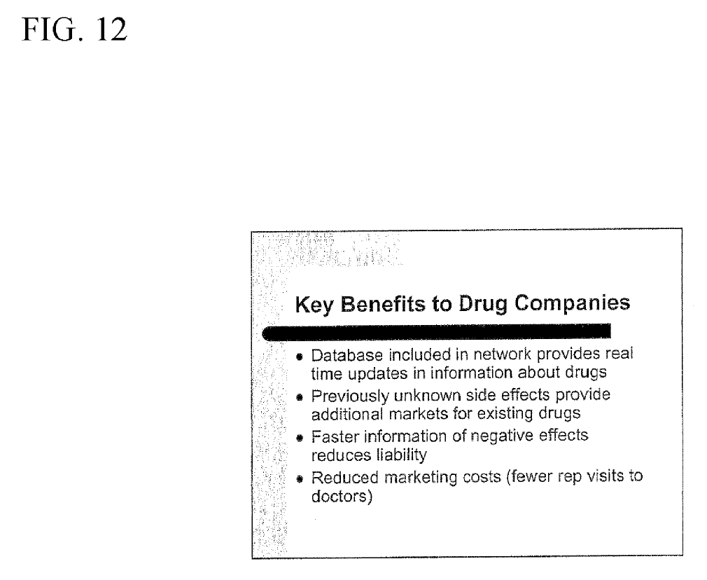

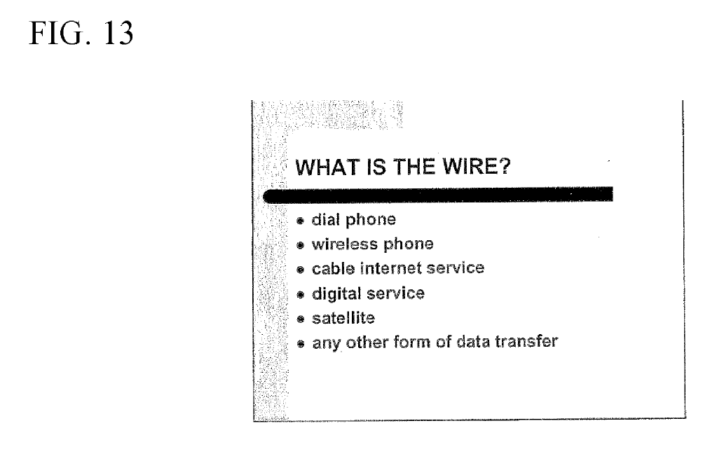

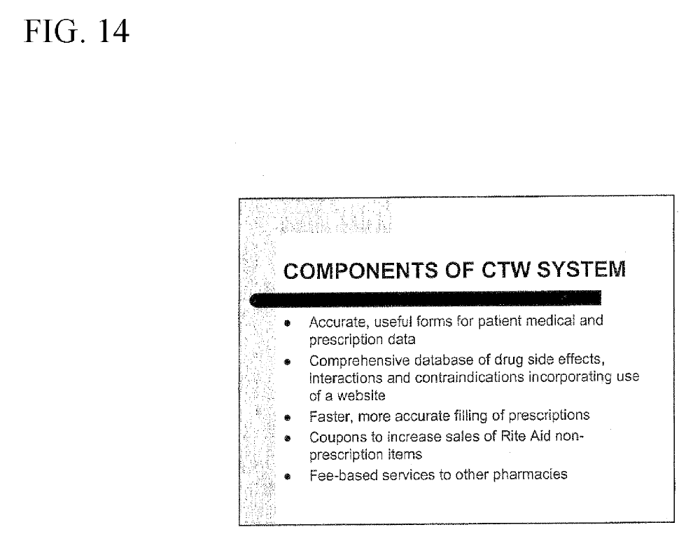

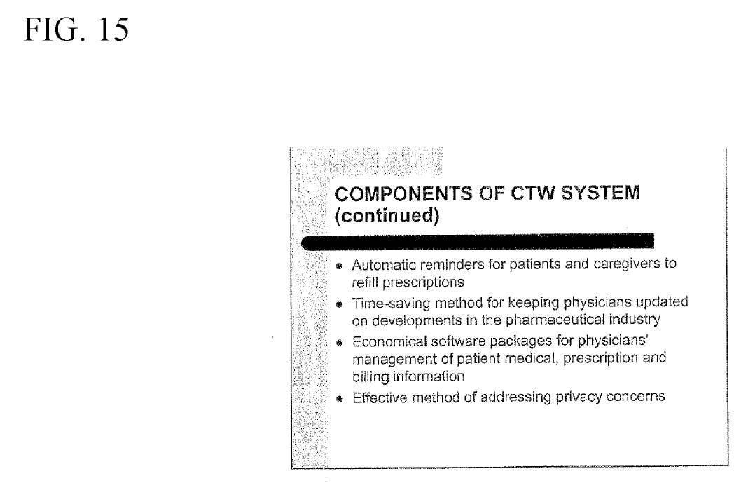

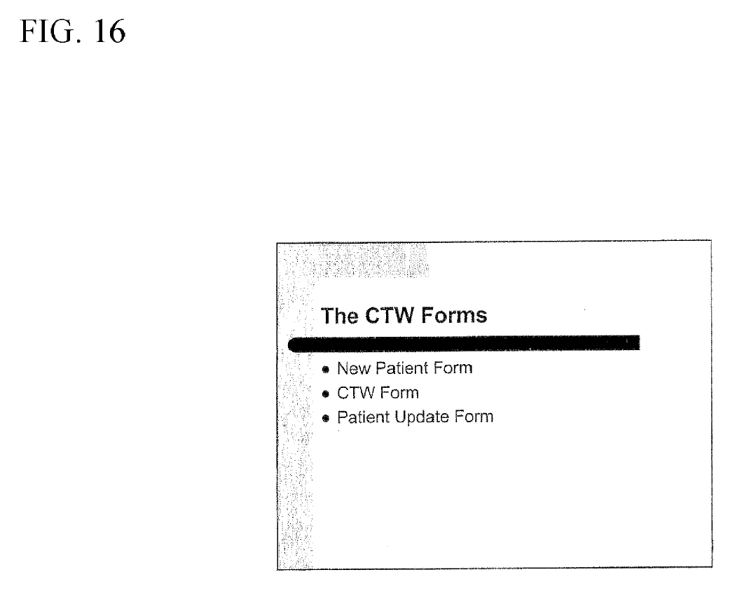

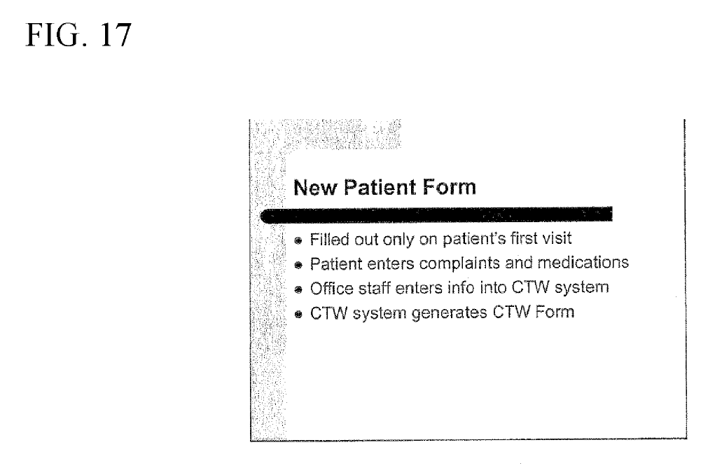

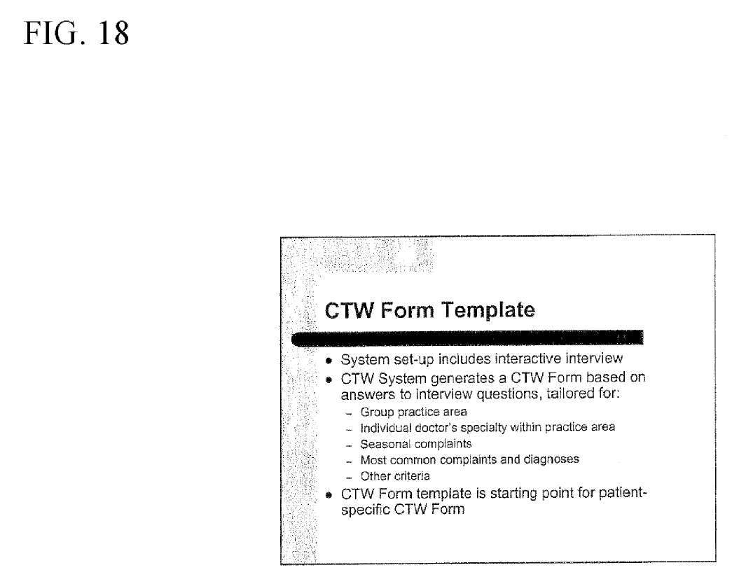

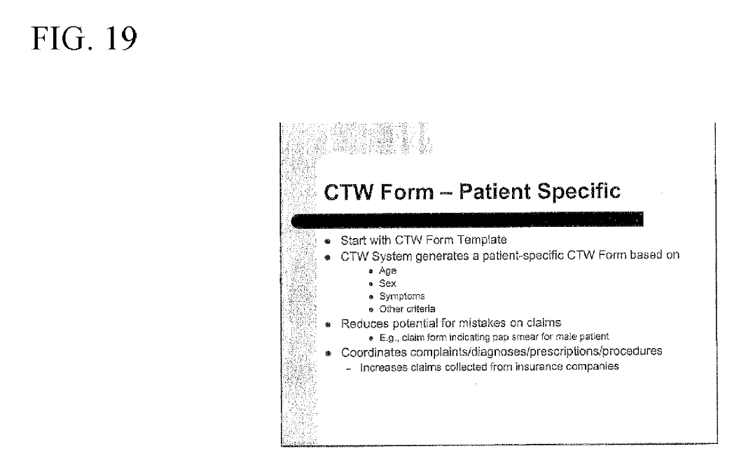

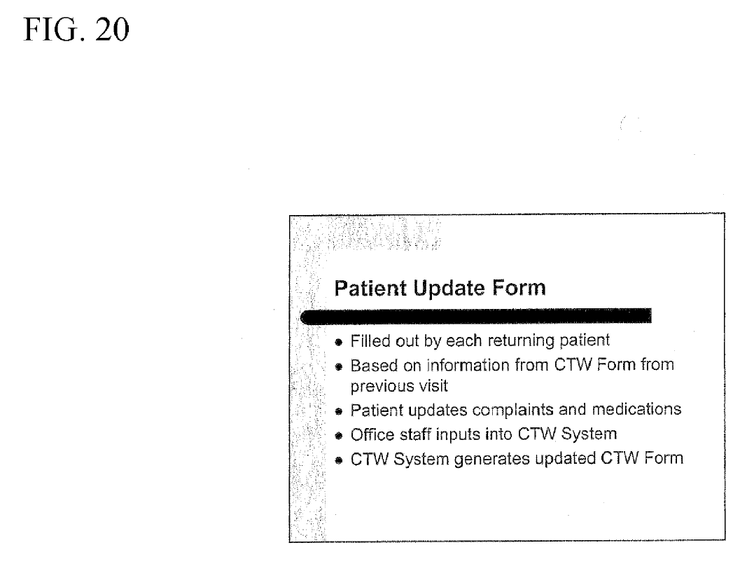

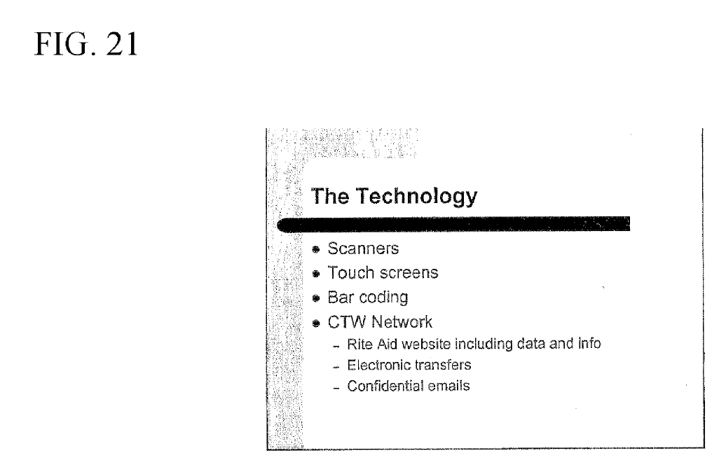

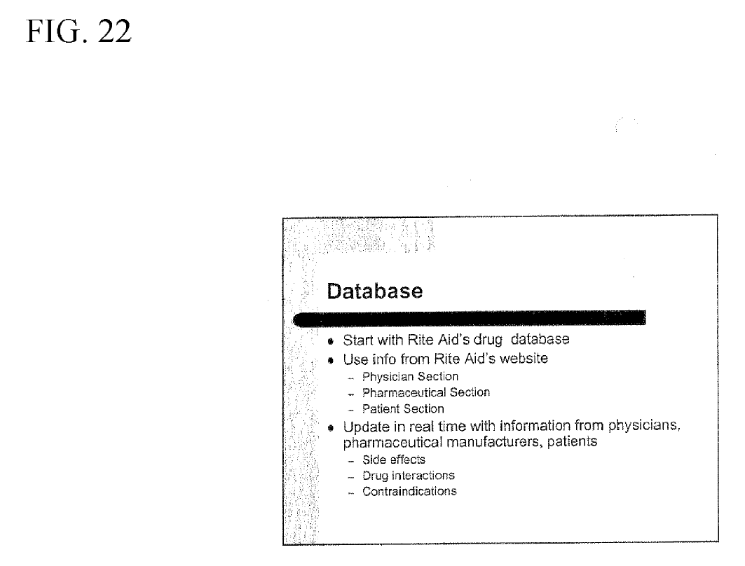

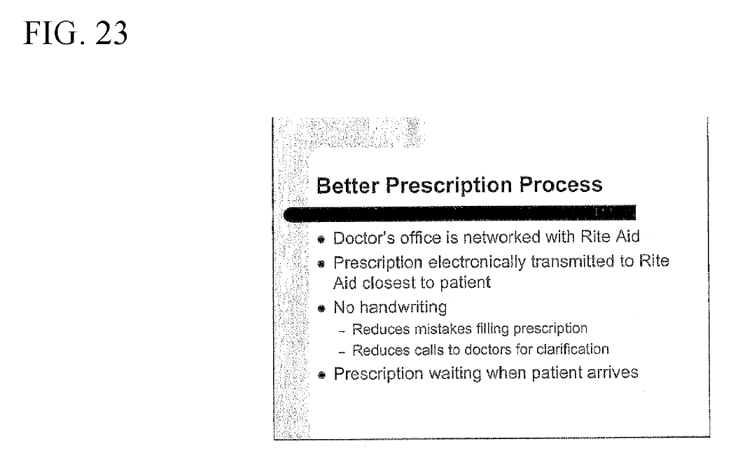

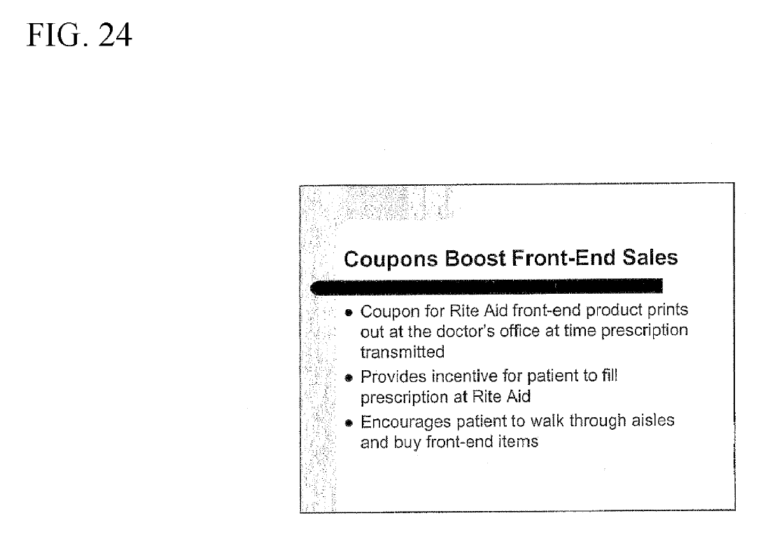

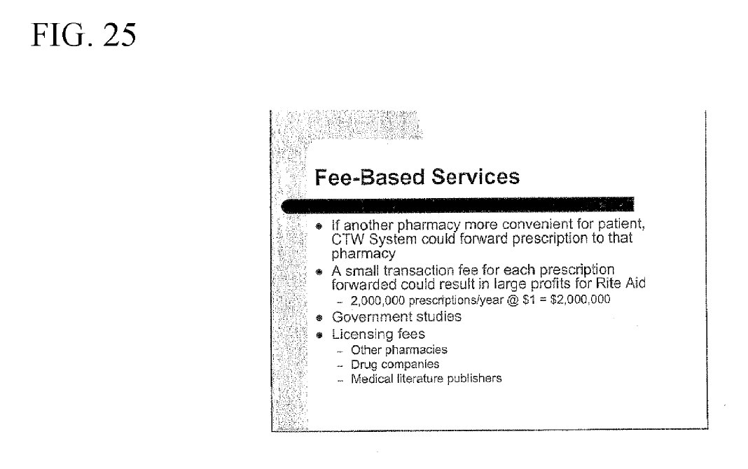

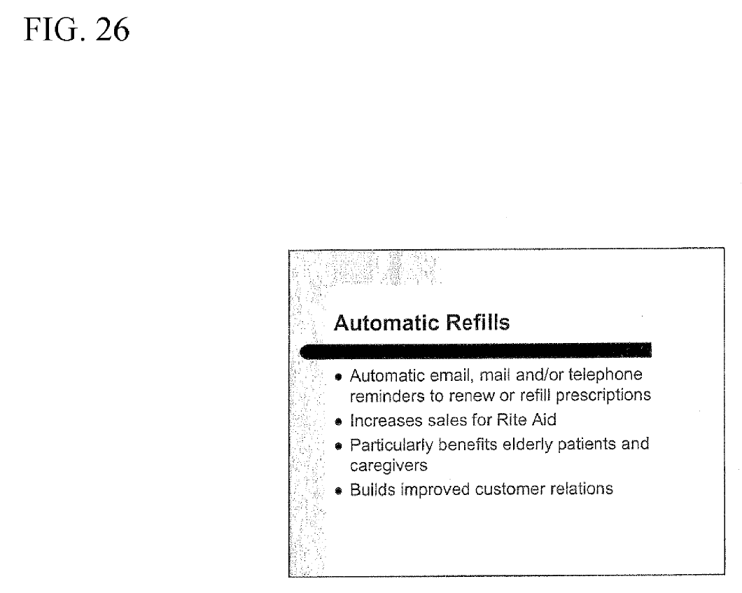

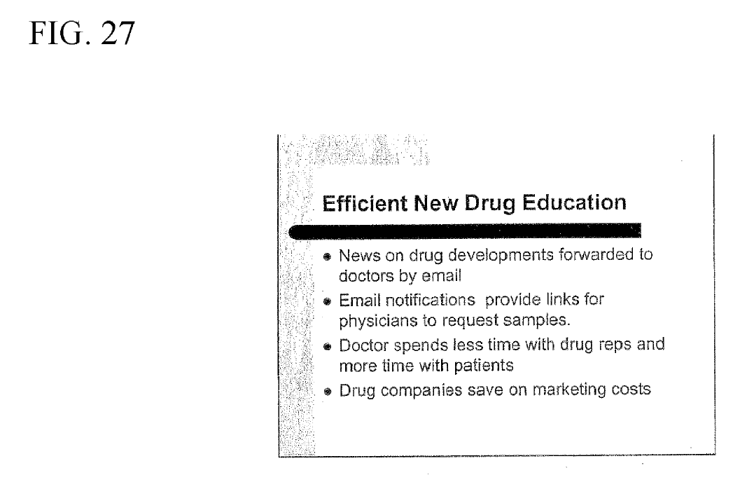

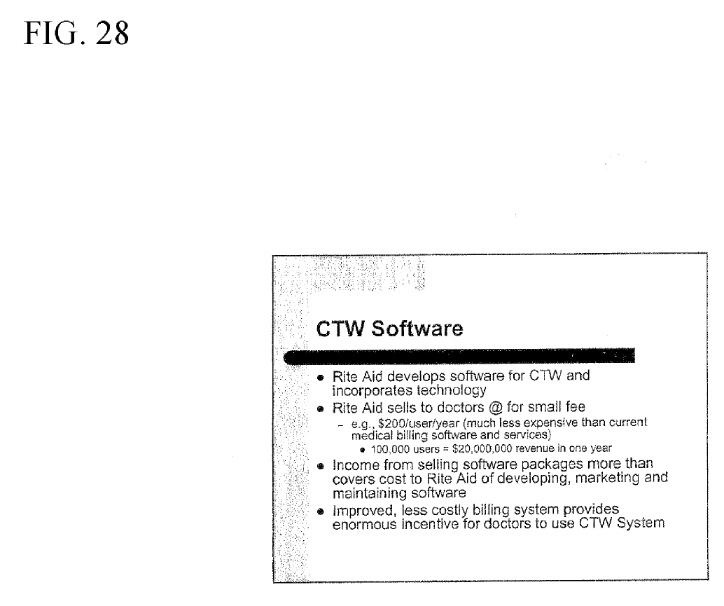

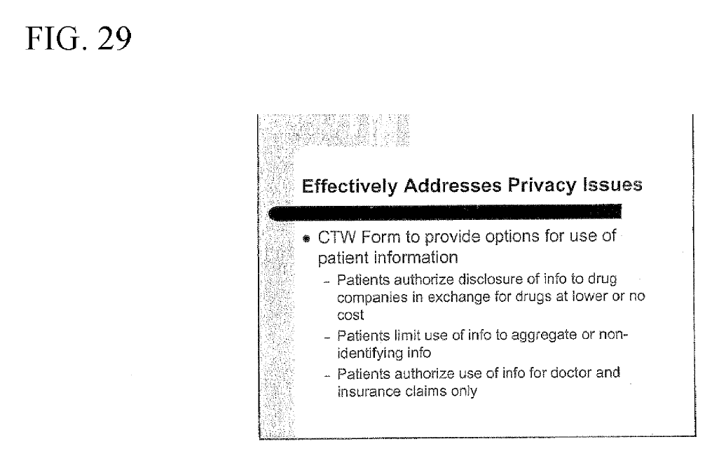

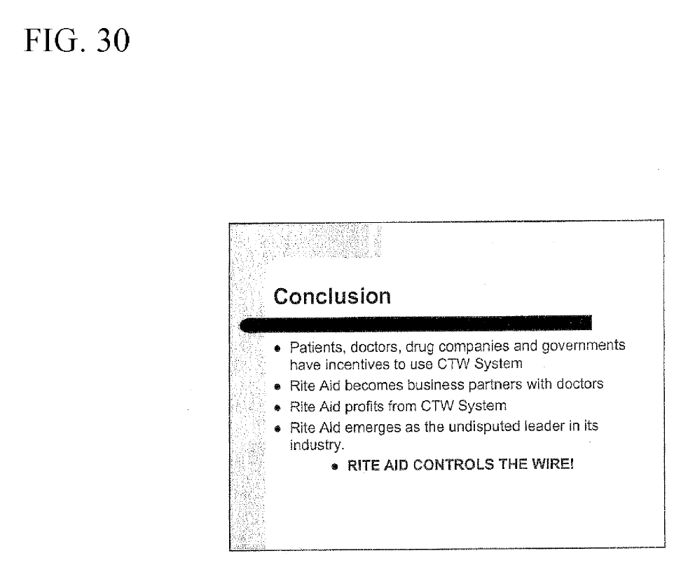

### DETAILED DESCRIPTION OF THE PREFERRED EMBODIMENTS

Preferred embodiments of the present invention will now be described, by way of illustration and not limitation, with reference to the accompanying drawing and attachments.

1. Description of Some of the Preferred Embodiments:

The preferred embodiments provide a computer based system, which allows diagnosis information, prescription drug and procedural information to be captured together at a physician's office. Upon entering a physician's office a patient fills out a form which is used to show the reason for his or her visit. On this initial form, the patient is likely to be required to disclose all known problems, any prescriptions and procedures for the known problems, and any drug interactions. Preferred embodiments include a number of ways in which in the patient could enter information. One embodiment utilizes a touch screen, which displays a graphical image of a male and/or female body. The patient will be able to touch the screen, designating which area or areas of the body the patient is seeking to have examined by the physician. In some embodiments, upon designation by the patient a personalized or specific encounter adapted based upon user identification (e.g., via the touch screen) can be provided. Additional preferred embodiments may include any number of ways that would allow the patient to communicate his or her information, including by hand.

Preferred embodiments assign each known problem with each prescription and/or procedure, by a problem number. If the patient has been a previous patient at the office, the form can use the problem number to show all known problems with all known prescriptions and procedures. Once the patient has completed the form, it is returned to personnel working at the office. This information that the patient provides is then entered into the system by personnel working at the physician's office.

The personnel could enter the information provided by the patient by hand, by using a scanner, or by any other method. In a preferred embodiment a simple scanner system could be utilized, which would use a bar code that could be unique to a particular section of the encounter form, such as to the diagnosis, drug prescription and/or procedural information. By using a scanner, the physician's office personnel can save valuable time, as compared to entering the information by hand. The personnel can then update the patient's records in the system. Any changes in prescriptions can also be assigned to the specific diagnosis and/or procedure by problem number. After the changes have been updated, a new form can be printed out and given to the physician at the point of encounter with the patient. This form can note any drug interactions or warnings, which may serve to alert the physician of any life-threatening situations. This form can provide the physician with the complete and detailed medical status of the patient.

After meeting with the patient, the physician's office normally fills out the encounter form, also known as a CPT or HICVA form. This form typically includes diagnosis information, but does not include prescription and/or procedural information. However, the preferred embodiments provide a method and system which can enable the physician's office to collect diagnosis information, prescription drug and/or procedural information together.

Again, the preferred embodiments include a system which can be setup on a physician's office computer. In some embodiments, a physician's office could be provided with a CD containing the software to download on their computer. This software can enable the physician's computer to not only capture, but to also send the diagnosis information, prescription drug and/or procedural information. Various means of capturing the information can be employed, including the use of simple scanners. The simple scanners could be used to scan the encounter forms directly into the system.

In some embodiments, the system enables the computer to generate an encounter form. A custom encounter form is advantageous because of the potentially long list of diagnoses, prescriptions and/or procedures that could be listed. Preferably the form can be varied by the system based upon a number of circumstances, thus creating a custom encounter form on a patient-by-patient basis. For example, the system could modify the list of potential diagnoses based on the season or time of year, patient's gender, patient's history, and/or other information. The encounter form can also be customized based on the information the patient provides on the initial form upon entering the physician's office. Further, the encounter form could be modified to include only the most common diagnoses, prescriptions and/or procedures which may be encountered by the particular physician. A modification based on the physician's common experiences could be particularly useful when the physician works in a particular specialty.

In some embodiments of the invention, the computer generated encounter form can include blank spaces for the doctor to fill out the prescription drug information. This can be particularly useful in the instances in which a specific diagnosis and/or procedure is not listed on the form. As an alternative to blank spaces, check-boxes could also be used, similar to those used commonly for a diagnosis information section. An incentive for using check-boxes could be increased accuracy. Blank spaces or check-boxes could also be used to fill in usage requirements, such as dosage information. In some embodiments the prescription drug information could be determined by the software which could analyze the entered diagnosis, once the form has been scanned in.

In some embodiments the data entered by physician can be done by hand, touch screen, or scanner. In some embodiments, a touch screen could display a male or female body, depending on the patient. The use of a touch screen system would allow a physician to point to an area of the body for purposes of relating to the diagnosis and/or treatment of the patient. In a preferred embodiments, a scanner system could work with a bar coding system. The bar coding system could have, for example, bar codes that are unique to a particular section of the encounter form, such as to the diagnosis, drug prescription, and/or procedural information. Among other things, this can reduce the amount of information required to be contained within the bar code data itself.

Once the data is collected, the software could automatically send the captured information to a central computer located remotely from the physician's office. This remotely located computer system, could be larger (e.g. a remote server system) and external in relation to the physician's computer system. In some embodiments, the software on the physician's computer can allow it to automatically tie into the remote central computer. In other embodiments, the central computer can call into the physician's computer to receive information obtained at the physician's computer. With the likelihood of most physician's offices having direct access to the Internet (or other computer network), the connections needed to transfer the information should be easily met. However, the systems can communicate in any known manner.

In some embodiments, the remote central computer could be managed by a physician or one or more outside companies, which may include pharmaceutical companies, drug-store chains, pharmacies, drug manufacturers, drug suppliers, and/or other outside companies. One potential advantage of this system is that it is particularly useful in connection with a large number of patients as it may provide data for detailed statistical analyses. These statistical analyses could become a major benefit to whoever is managing the remote central computer. For example, a pharmaceutical company and/or other entities can find the information particularly helpful for the purposes of advertising. In this regard, pharmaceutical companies can, e.g., create coupons, special savings and/or the like deals and offer the same to specific individuals (e.g., particular patients), to individuals within specific geographical regions (such as, e.g., using advertising via local newspapers, etc.) and/or the like.

Pharmaceutical manufacturers and other entities can also be able to see if there are other uses for their drugs then what they may have intended. The benefits arise not only from having the information for their own needs, but also because of the direct financial incentives that can be realized when another company wants to buy the information. In further examples, the diagnosis, prescription drug and/or procedural information can be used together to evaluate geographical issues related to drugs, and/or determine unknown side effects of drugs. In preferred embodiments the information obtained at the remote central computer could be discrete, in providing no personal information relating to the patient.

The drug stores who market the prescription drugs and/or other entities could also benefit from the data which can be obtained from this system. For example, drug stores and/or other entities would be able to tailor their advertisements to physicians and/or patients (e.g., which can in preferred embodiments be effected through the physicians) based on prescription and or physician orders and/or the like. Among other things, drug stores and/or other entities could also be able to use this information to incorporate coupons, special offers, etc., for drugs and other items sold at the drug store including non-drugs. Similarly, drug stores and/or other entities could also sell pertinent information relating to, for example, physician and/or prescription drug orders to pharmaceutical companies and/or other entities.

In some embodiments, when a physician's order is made, the drug company or the like can quickly, such as, e.g., within a minute or a few seconds, remit a coupon (e.g., which can be, e.g., printable in some embodiments) which can be given to the patient from the physician. For example, the physician can potentially hand the patient the patient's prescription for drugs along with a coupon provided by a drug store or the like. In this manner, a drug store or the like can provide extra incentive for a patient to purchase the drug at the drug store. In instances where electronic documents or the like cannot be forwarded (such as, e.g., where a physician communicates by telephone), the drug store or the like could provide a coupon ID # for recording or the like by the physician and/or can provide a special deal in another manner. Physicians can also reap numerous benefits and safeguards from the present invention. For example, the preferred embodiments may also help to maintain a clear record, on a patient-by-patient basis, of drugs actually given to that patient, which could enable physicians to avoid the mistake of giving improper drugs to patients. The system also enables the physician to process insurance matters faster and the ease of operation may help to reduce malpractice insurance.

Another potential advantage of the invention is that the software can be very inexpensive for physicians. Further, a physician's costs for the software may be subsidized by other large companies and or pharmaceutical companies who wish to obtain information that has been captured by the system. The large companies may also be able to subsidize their costs associated with the software because of the benefits they can receive from having access to the information provided by the system. For example, selling the information to other companies or government agencies. This shows that there are tremendous financial incentives for the party in control of the data which is collected by the invention.

In the preferred embodiments, this system allows for numerous other potential avenues of revenue and ease of use advantages. For example, if a recall or alert is announced, the system allows for prompt action. Further examples include the ease of sharing prescription data among drug-stores and numerous other conveniences which can be created because of the system. Modern technological advances such as touch screens, handheld devices, or other remote frequency devices be may employed to work with this system. However, paper forms using scanners are the least costly. Any release of the information captured by the system should be done in accordance with the HIPPA privacy requirements, to ensure the patient confidentiality.

Further in some instances, patients could be required to sign an agreement enabling the information captured by the system to be dispersed. However, in some embodiments information captured and transmitted outside of the physician's records and control, could be limited to exclude the patient's personal information.

2. Description of Some Other Illustrative Embodiments

This section describes aspects of some other illustrative embodiments of the invention.

Controlling the Wire

The company that controls the wire controls the valuable information that flows through the wire.

The wire can be dial phone, wireless, cable, digital, satellite or any other form of data transfer.

One goal of this venture is to capture the prescription data at the physician's office. What can be done with that information is explained in the revenue section.

Currently, existing medical billing systems do not attempt to accomplish this. This is true for, inter alia, two reasons. First, the current systems only try to facilitate the appointment and billing processes, because there is no financial incentive for the physician to record prescription data. The second reason is that to capture this data is seen as very time consuming.

Preferred embodiments can provide solutions to both of these problems.

Privacy

This is a very current subject. The patient will be required to sign on the original form, as to how they wish their information to be handled. The following examples could be used:
1. All data can be used to determine the effectiveness of drugs. Your information will be forwarded to the manufacturers to determine if you qualify for reduced price or free drugs. Your generic information only may be used for government and industry studies.
2. Only your generic data can be used for study purposes only.
3. No information may be used, with the exception of processing your medical claim.

The patient hook is the ability to receive discounted and/or free drugs, as well as participation in drug studies without their name and address being forwarded.

Collecting the Information

Collecting the information is one notable aspect to this process as it is in all other computer system applications. In the preferred embodiments of this system, the data collection will be done at the source: e.g., at the physician's office.

Upon arrival in the physician's office, as customary, a new patient fills in a form with all known problems. The form will also include any prescriptions for known problems. This is standard, with this exception, that we will assign each known problem with each prescription by problem number.

If the patient has been previously treated, in this office, the form will show all known problems with all known prescriptions for those problems, by problem number.

Any changes in the patient's problems and or prescriptions will be noted on the form. When the patient has completed this form, it is returned to the front desk for processing.

The front desk personnel will enter in the system any changes for this patient.

A new form will be printed and given to the physician at the point of encounter with the patient.

This encounter form will note any drug interactions or warnings so that the physician may make possible lifesaving alterations in medication immediately. We know that it is impractical for a physician to know every possible interaction and warning. This is a positive for both the physician and the patient.

With this information, it shows the physician a clear picture of the medical status for this patient. This saves the physician time and possibly court action if there is a drug interaction or a drug warning for this patient, or the patient does not inform the physician of current medications.

Another difference in this form versus forms in other medical systems, is that this is designed to use scanner technology to easily enter encounter data back to the system.

The physician simply marks on the form in the appropriate spot next to the correct diagnosis and procedures for this encounter.

There are too many diagnosis and procedures to fit on a single page, even if it is by physician specialty.

The system can accomplish this by only printing the diagnosis and procedures that are most often used by this specific physician. This is done by the physician choosing what should be printed, or the system can auto-generate which diagnosis and procedures as it relates to this patient's medical history and or the time of the year for specific ailments and treatments.

This eliminates obvious errors such as a prostate examination for a female patient. This may seem as somewhat inconsequential, but I know that this is a problem in medical billing systems. Many systems require the coding of diagnosis and procedures by the medical standards books. This allows entry personnel to select an incorrect code.

Depending on the state, only a given amount of time is allocated for the processing of any Medicaid charges. This results in physician write-offs. This system enables the physician to process other types of insurance in a faster manner as well. This will increase cash flow for the physician as a result.

Easy scanning of data in the system is of importance in preferred embodiments.

If a specific diagnosis or procedure were not on the form, then the usual method of writing in would be done, preferably with touch screen technology or at the least, not allowing incorrect diagnosis and procedures.

By using the pre-printed form as described, handwriting will be at a minimum of occurrences.

All diagnosis, procedures and prescription changes are assigned to each other, by problem number.

When the patient returns to the front disk, the form is scanned in the system. Again, any drug interactions will be noted and appropriate action would be taken immediately.

Using the scanner in conjunction with this form, the physician's office personnel will save more than enough time (as compared to existing systems) to also enter all of the prescription data.

This also has the potential to save lives, malpractice insurance, and physician time. This is one of the hooks that will give this system a major advantage over other medical systems. There are other hooks, and they will be discussed later.

This system can be designed to use touch screens or hand helds or remote frequency devices if deemed useful. Paper forms using scanners are the least costly.

At regular intervals, all of the appropriate data will be down loaded to the Rite-Aid (or other company) system (see, e.g., “revenue” below).

Medical claims to insurance companies would be handled in the normal fashion of current medical billing systems.

Revenue

In some preferred embodiments, there are 9 potential distinct sources of new revenue that may be achieved. Some embodiments can employ one or more of these novel revenue methods.

Revenue 1: For all of those patients that have chosen to allow data to be sent to the pharmaceutical manufacturers, as I am sure you know, they will pay dearly for that information. Currently, the manufacturers know that a drug has been prescribed, but they do not know for what purpose. The manufacturers know that a drug works for the intended ailment. The manufacturers do not know that this drug works for patients with other ailments, at specific dosages.

Revenue 2: Federal and state governments routinely pay for drug studies as to efficacy and side effects within certain groups by age, sex, race, etc. There will be a voluminous amount of information that will be collected by this system. The outlets to sell this information are also great.

Revenue 3: If a pharmaceutical manufacturer has a recall or an alert, your system allows for prompt action. This forges a relationship with Rite-Aid (or any other company or entity) and the patients and the pharmaceutical manufacturers.

Revenue 4: If a physician wishes to request drug samples, it is accomplished through your system to the pharmaceutical manufacturers.

Revenue 5: If you wish to allow stores other than your own to receive prescription data, a fee would be charged to that company. A small fee for each prescription sent would generate large revenue.

Revenue 6: To help alleviate the backlog in the filling of prescriptions, the prescription would be sent to the patient's most convenient Rite-Aid (or any other company or entity) location. This will also save the pharmacist time in the process of deciphering the paper prescription as to the drug name and dosage requirements. Sometimes with only the paper prescription, a call back to the physician is required. This will be eliminated along with the drug warnings or drug interaction calls back to the physician. This enables the pharmacist to fill the prescription before the patient arrives at the store. It saves the customer, physician and pharmacist time and hassle. Of course, only when they shop at Rite-Aid (or any other company or entity) stores.

Revenue 7: Through the system, the manufacturer has a direct line to the physician. Any information transferred is through your system. If a manufacturer can save just a few “in person visits” per year to a physician to inform of new drug usage or to drop off samples, this enables the physician to see more patients, resulting in increased revenue. This would also save the manufacturers labor costs.

Revenue 8: In a partnership with the manufacturers, an e-mail system or post card reminder or even a phone contact system to renew or refill prescriptions could be done. As should be appreciated based on this disclosure, there is a great need for this as it pertains to elderly patients. This could also be used to notify a third party for this function as well. We all know someone who cares for an elderly parent or needy friend that would make good use of this. It is readily apparent that this would increase sales of prescriptions, but what about the public relations aspect.

Revenue 9: The physician has the ease of operation and possible reduction of malpractice insurance. The physician will have more time to see patients. These are hooks for the physician to use your system. However, if the system were a minimum cost to the physician, that would be another major hook. Many systems charge by the amount of revenue generated and are very expensive. The companies that sell these packages have only the software as revenue. With my approach, there are other revenue sources. If the revenue from marketing this system were to be neutral, there would still be much revenue to reap. As an example, If you were to charge $100.00 per user, per year, that would be a huge incentive to lease the system. If 100,000 users were sold, that would by itself generate $10 million per year. When the physician contracts with you to use your system, that makes the physician a business partner as well. This can only be a positive for Rite-Aid (or any other company or entity).

3. Description of Some Other Illustrative Embodiments

This section describes aspects of some other illustrative embodiments of the invention.

Overview

Controlling the Wire refers to controlling the capture, management and use of vast amounts of medical and prescription data using a unique method which will direct sales to Rite Aid (or any other company or entity) while benefiting patients, physicians, pharmaceutical manufacturers and federal and state governments. The system through which Rite Aid (or any other company or entity) will control the wire is referred to as the “CTW System.”

The CTW System will use technology to dovetail with a company's (such as, e.g., Rite Aid) goals of boosting its volume of prescription and front-end sales, improving its margins, and enhancing its public image. Direct and indirect revenue and business opportunities for Rite Aid (or any other company or entity) resulting from the CTW System are discussed below.

What is “The Wire”?

In the medical and pharmaceutical information system context, the wire is the technology used to collect, manage and transfer patient information. The wire can be dial phone, wireless phone, cable internet service, digital service, satellite or any other form of data transfer.

Shortfalls in Current Systems

Inadequate Data Collection and Use. Currently, the patient information collected by physicians is not being used to full advantage because no comprehensive system exists for collecting and managing medical and prescription data. Existing medical appointment and billing systems fall far short of managing collected information in a meaningful way.

Furthermore, a considerable amount of useful (and profitable) medical and prescription information remains uncollected for two main reasons. First, no financial incentive exists for the physician to record prescription data. Second, physicians see the capture of additional data as overly time consuming.

In the preferred embodiments of the invention, a CTW System is provided that can solve both problems.

Inadequate Forms. Physicians currently use a standard encounter and billing form for every patient. The standard form lists common diagnoses for the physician's practice. However, even when tailored for a particular specialty, a single page form cannot accommodate all the potential diagnoses, drugs and procedures relevant to that specialty.

In addition, standard forms often contain diagnoses and procedures irrelevant to a particular physician's practice and/or specific patients. Having extraneous diagnoses and procedures on the encounter and billing form increases the potential for errors (for example, the entry of a prostate exam for a female patient). Such errors present a significant problem in current medical billing systems. Many systems require data entry personnel to code diagnoses and procedures according to medical standards books. Such manual input often results in the entry of an incorrect code.

States have different statutes of limitations applicable to processing Medicaid charges. The incorrect entry of a diagnosis and/or procedure frequently results in rejection of claims by Medicaid. Similar problems arise in connection with private insurance. Physicians' offices must then review the claim and their records to determine the appropriate corrections, a procedure which is time-consuming and costly. If the physician's office does not correct the claim form within applicable time limits, Medicaid and private insurance companies may never pay the claim. Physicians therefore write off significant dollar amounts of claims because of their own inadequate billing systems.

Also, in the near future Medicare is going to require that requests for reimbursement include a diagnosis code which comports with the procedures for which reimbursement is requested. Unless doctors have improved reimbursement request procedures, they will risk losing even more money under the new regulations.

In the preferred embodiments, a CTW System resolves the problems presented by standard encounter and billing forms.

The CTW System Solution

The CTW System incorporates a number of key components, integrated by technology, which will significantly improve the capture, management and use of patient medical and prescription data. A company's control of this data will bring new customers through its doors and increased sales to its cash registers.

Some notable components of the CTW System are:
1. Accurate, useful forms for patient medical and prescription data;
2. Comprehensive database of drug side effects, interactions and contraindications incorporating use of a website;
3. Faster, more accurate filling of prescriptions;
4. Coupons to increase sales of a company's front-end items (such as, e.g., other products within a drug store, such as, e.g., Rite-Aid, even such unrelated to medicine);
5. Fee-based services to other pharmacies;
6. Automatic reminders for patients and caregivers to refill prescriptions;
7. Time-saving method for keeping physicians updated on developments in the pharmaceutical industry;
8. Economical software packages for physicians' management of patient medical, prescription and billing information; and
9. Effective method of addressing privacy concerns.

A detailed discussion of each component, according to some illustrative and non-limiting embodiments, follows.

1. Accurate, Useful Forms for Patient Medical and Prescription Data

Collecting the information represents the key to the CTW System, as in all other computer system applications. In the CTW System, the physician's office collects the data. The forms used in the CTW System will improve the data collection process in two significant ways: (1) the forms will contain more accurate and relevant data than standard forms currently provide, and (2) the efficient technology used for data collection will streamline the procedures used by physicians' offices to capture and control medical and prescription information.

The Forms

The CTW System will rely on three primary forms: (1) the New Patient Registration Form (for new patients only); (2) the Patient Update Form (for existing patients); and (3) the CTW Form (for new and existing patients).

The New Patient Registration Form. The New Patient Registration Form will ask a new patient to list all known medical complaints, as well as the prescription medications taken for each such complaint. Patients will complete the New Patient Registration Form only on the patient's first visit to the physician.

The patient will return the New Patient Registration Form to the front desk. The front desk personnel will then enter the form's information into the CTW System database. The CTW System will then generate a CTW Form containing only diagnoses and procedures relevant to such patient's medical history. Eliminating irrelevant information from the intake form significantly reduces the opportunity for obvious errors, such as indicating a circumcision for a female patient.

The Patient Update Form. Upon arrival, the returning patient will receive from the front desk a Patient Update Form. The Patient Update Form will contain all of the information previously available to the physician with respect to such patient (based on the patient's CTW Form from his prior visit). The patient will mark any corrections and/or updates (e.g., in medications and symptoms) directly on the Patient Update Form, and will return the updated form to the front desk. Personnel will enter the new information into the database. The CTW System will then generate an updated CTW Form for such patient.

The CTW Form. Each physician's practice will have a basic CTW Form which contains only complaints, diagnoses and procedures frequently used by that physician. Generating the basic form will require a simple one-time set-up by the physician with guidance from the CTW System. The capability of the system can vary depending on the physician's desires. If appropriate for a physician's practice, the basic CTW Form can vary from season to season, depending on the types of medical complaints most common to a particular season. After the physician has a history with the CTW System, the CTW System can automatically make adjustments to the basic form. Furthermore, the basic form can vary from doctor to doctor within a practice based on their individual specialties.

The CTW System will then tailor the CTW Form for each patient, based on such patient's medical history, prescription history and current complaints. Each complaint will be combined with the procedure recommended for the complaint, as well as the medication prescribed for such complaint (a “complaint/procedure/medication unit”). Each complaint/procedure/medication unit will be assigned a CPM Code. The CPM Code will reduce the potential for errors in reimbursement requests, resulting in more and speedier reimbursements for physicians. This aspect of the CTW System alone will provide powerful incentive for physicians to use the CTW System.

Because the CTW System drug database will contain an updated database of known drug interactions, side effects and warnings (as discussed in more detail, below), the form will contain a warning if the patient is taking two or more medications with the potential for a negative interaction, as well as other potential side-effects and contraindications. This information will afford the physician an improved picture of the patient's medical status, thus enabling the physician to make immediate, possibly lifesaving, adjustments to treatment.

The Technology

Scanners and Touch Screens. The CTW System will use simple, efficient technology: the scanner and touch screen technology. The scanner will facilitate collection of patient encounter data, both of the kind currently collected, as well as relevant data not currently collected. The system's design can also incorporate hand helds, barcoding and/or remote frequency devices, if deemed useful. Paper forms using scanners present the least costly alternative. If the generated form does not contain a specific diagnosis or procedure, office personnel would add the appropriate diagnosis or procedure using touch screen or other technology.

The touch screen or computer screen could include a three-dimensional rotating diagram of the human body. The patient or office personnel could touch or click to enlarge and indicate the area affecting the patient. The CTW System would use the enlarged area touched or clicked to generate a CTW Form most useful for the patient's current complaint. The CTW Form would include the most common diagnoses, procedures and medications relevant for the indicated area of the body, ranked in order of statistical occurrence based on current information from the database discussed below. Using the CTW Form will provide crucial up-to-date information for the physician and will reduce the need for handwriting, both of which will minimize the potential for errors.

Using the scanner in conjunction with the customized form will take significantly less time for the physician's office personnel than the time taken by current medical billing systems. The time saved will present ample opportunity for entry of the patient's prescription and treatment data. In addition, the increased accuracy will reduce the amount of time physicians spend on administrative matters.

Physicians' offices would continue to process health insurance claims as they do with current medical billing systems.

At regular intervals, a company (such as, e.g., Rite Aid) can upload all of the appropriate data from the physicians' offices. In some embodiments, it should be understood based on this disclosure, such could be done in real time, such as, e.g., if software is maintained substantially at the server side. Privacy concerns are addressed below.

Patient Database; Smart Card

The CTW System could include a smart card which communicates with a patient database. The patient database would include medical information from the patient's primary care physician, as well as specialists, outpatient medical centers, hospitals and other medical care providers. In this way, the database will provide a complete picture of the patient's medical conditions, procedures, and medications. The database could also include the patient's medical insurance information.

The smart card would look like a credit card, including the magnetic strip. The magnetic strip, itself, would not contain the patient's medical information, as others have contemplated medical smart cards. Instead, when swiped, the strip would provide a connection to the patient database, and would grab the relevant patient information (similar to the electronic credit card charge approval process). This way, the information is always up-to-date, as opposed to having a strip with stale medical information.

The patient database and smart card would provide medical care providers with access to accurate medical information about their patients. Such access could be crucial in the event of a medical emergency, particularly when the patient cannot communicate with emergency medical personnel. In addition, it will provide physicians with better medical insurance information, thereby improving insurance reimbursements.

2. Comprehensive Database of Drug Side Effects, Interactions and Contraindications

The CTW System will contain an updated database of known drug interactions, side effects and warnings (the “CTW Database”). The starting point for the CTW Database will be the prescription drug database currently maintained by Rite Aid (by way of example). The current database will be updated via a website consisting of three areas: (1) a section accessible only by physicians (the “Physician Section”), (2) a section accessible only by pharmaceutical manufacturers (the “Pharmaceutical Section”), and (3) a section accessible by the general public (the “Patient Section”).

Through the Physician Section, Physicians will report to Rite Aid (or any other company or entity) their patients' reactions to drugs and observations regarding the efficacy of drugs they are prescribing, as well as the conditions for which they are prescribing specific drugs. Through the Pharmaceutical Section, individual manufacturers will report to Rite Aid (or any other company or entity) updates on such manufacturer's drugs, including new drugs, new uses for existing drugs, and alerts and recalls. Through the Patient Section, patients will be able to report to Rite Aid (or any other company or entity) the effects of the drugs they are using. As a result, Rite Aid (or any other company or entity) will serve as a central repository for the latest information on drug efficacy and reactions. As such, Rite Aid (or any other company or entity) will be in a position to quickly distribute important new findings to pharmaceutical manufacturers, physicians and patients.

Rite Aid (or any other company or entity) will benefit from the CTW Database indirectly through the benefits recognized by physicians, pharmaceutical manufacturers, patients and governments.

Physicians cannot know every possible interaction, side-effect and contraindication for the wide variety of medications on the market. The CTW Database will benefit the physician by streamlining administrative practices and reducing the risk of legal liability (and potentially reducing medical malpractice insurance premiums) at minimal effort. These benefits will provide incentives for physicians to use the CTW System and prefer sending their patients' prescriptions to Rite Aid (or any other company or entity) over other pharmacies.

The pharmaceutical manufacturers will benefit from receiving medical information to which they would otherwise not have access. Currently, the manufacturers know that a drug has been prescribed, but they do not know for what purpose. The manufacturers know that a drug works for the intended ailment, but they do not know that the drug works for patients with other ailments, at specific dosages. For example, although Monoxodil was originally prescribed as a blood pressure medication, doctors reported increased hair growth on patients using it. Monoxodil is now primarily used to generate hair growth. The CTW Database will afford pharmaceutical manufacturers an enhanced opportunity to evaluate potential uses of their drugs for medical conditions not previously contemplated by the manufacturer, and to increase profits by marketing the drug accordingly.

In addition, pharmaceutical manufacturers will discover negative side effects, drug interactions and contraindications sooner. This will enable the manufacturers to improve warnings and information included with their medications. Also, the CTW System will facilitate prompt notification of patients using a particular medication in the event of a recall or an alert, thereby reducing the manufacturer's potential liability with respect to its drugs. This improved functionality will enhance relationships between Rite Aid or the like and its patients, between Rite Aid and the pharmaceutical manufacturers, and between Rite Aid and physicians.

Patients will benefit from the CTW Database because it will speed up their receipt of important information about drugs they are using, thus reducing their risk of dangerous drug reactions and interactions. The benefits provided by the additional information will serve as incentive for the pharmaceutical manufacturers to offer discounted and free drugs to patients, which in turn will improve Rite Aid or the like's relationship with patients and encourage new patients to fill their prescriptions at Rite-Aid or the like.

In addition, governments will benefit. Drugs often work differently, depending on a patient's race, age, sex and other factors. Federal and state governments routinely commission drug studies as to efficacy and side effects within certain groups by race, age, sex, etc. The CTW System will collect a voluminous amount of information which governments will find useful.

ILLUSTRATIVE BENEFITS. Pharmaceutical manufacturers will be willing to pay for the information contained in the CTW Database. Rite Aid or the like could arrange to provide such information to the pharmaceutical manufacturers (either across the board or to only specific manufacturers with whom Rite Aid or the like has contractual arrangements) in exchange for cash payments, reduced drug prices, some combination of the two, or other consideration. Such payments/cost-savings can be used to improve Rite Aid's margins, which would obviously directly improve its profitability. Alternatively, Rite Aid could reduce prescription drug costs to consumers. Reducing prescription costs to the consumer would enhance customer relations.

3. Faster, More Accurate Filling of Prescriptions

The CTW System will connect the physician's office directly to Rite Aid or the like. The physician will electronically transmit prescriptions to the patient's most convenient Rite Aid or the like. Rite Aid or the like will then transmit to the physician a list of prescriptions which the patient has had filled at any Rite Aid or the like, together with information regarding potential drug interactions and contraindications. This two-way communication will improve the prescription-filling process in several ways.

First, the procedure will improve patient care because it will increase the accuracy of the physician's information about the medications other doctors have prescribed for his patient. This information will provide the physician with the opportunity to make any necessary adjustments to his patient's medications.

Second, pharmacists will have fewer calls to physicians to alert them about drug interactions and contraindications because the CTW System will already have alerted the physician about such problems when the office enters the prescription.

Third, pharmacists will no longer need to call physicians because of difficulty reading the physicians' handwriting. In addition, the direct transmission of prescriptions will eliminate mistakes resulting from problems deciphering handwritten prescriptions.

Fourth, electronic transmission will also take less time for the physician's office than calling in a prescription.

Finally, when a patient arrives at Rite Aid or the like, the pharmacy will have the prescription ready and waiting for her.

The expedited filling of prescriptions will save the customer, physician and pharmacist time and inconvenience, thus providing incentive for physicians to use the CTW System and for patients to shop at Rite Aid or the like.

4. Coupons to Increase Sales of Front-End Items

When a physician's office transmits a prescription to Rite Aid or the like, Rite Aid or the like will transmit to the physician's office a coupon for a front-end Rite Aid product, such as bandages or aspirin. The coupon could be specific to the physician's specialty, the patient's age, or other criteria. The office will print out the coupon and give it to the patient (or the coupon can print at the Rite Aid pharmacy and be ready for the patient when she arrives). The coupon will not only provide an incentive for the patient to purchase that product, the patient will have a reason to walk through the Rite Aid aisles instead of heading straight for the pharmacy. Once the patient is in the aisles, there will be a greater likelihood that she will purchase additional items.

5. Fee-Based Services

In certain instances, participating physicians' patients may prefer to fill their prescription at a pharmacy other than Rite Aid or the like (for example, if the patient lives much closer to the other pharmacy). The CTW System could generate revenue for Rite Aid or the like even if another pharmacy fills the prescription. The physician's office would enter the prescription into the CTW System. The entry would indicate at which pharmacy the prescription is to be filled. The CTW System would transmit the prescription to the appropriate pharmacy, where it would be filled and ready for the patient when the patient arrived. Rite Aid would charge a transaction fee to any pharmacy participating in this program. A small fee for each prescription sent could generate significant revenue for Rite Aid.

In addition, Rite Aid or the like could generate fees by licensing the software to other pharmacies, pharmaceutical manufacturers and others.

6. Automatic Reminders for Patients and Caregivers to Refill Prescriptions

The CTW System will provide automatic email, mail and/or telephone reminders to renew or refill prescriptions. Elderly patients and their caregivers will find such a function particularly useful. Not only will it provide a timely reminder, it will enable patients and their caregivers to determine if they are taking proper amounts of the medication by evaluating the amount remaining at refill time. Aside from the obvious benefit of increasing sales of prescriptions, a reminder function would reap tremendous public relations benefits for Rite Aid or the like.

7. Time-Saving Method for Keeping Physicians Updated on Developments in the Pharmaceutical Industry

The CTW System will keep physicians up to date via email on new developments in the pharmaceutical arena. The CTW System will also make it easier for physicians to obtain drug samples. The email notifications will provide links for physicians to request samples. After a couple of clicks, the samples will be on their way.

The CTW System will significantly reduce the amount of time physicians will need to spend with manufacturers' representatives. The time physicians save by obtaining drug information via the CTW System, rather than through in-person meetings with pharmaceutical manufacturer representatives, will allow the physicians to see more patients, which will benefit the physicians financially and improve patient care. Rite Aid or the like will benefit by improved goodwill with doctors. Pharmaceutical manufacturers will also benefit by decreased labor costs.

8. Economical Software Packages for Physicians' Management of Patient Medical and Billing Information

Rite Aid could provide the CTW System to physicians at minimal cost. Many physicians use medical billing services which charge a percentage of the claims collected, resulting in enormous expense to the physician. The companies selling these packages have only the software as revenue. Because the CTW System will provide Rite Aid or the like with a number of other revenue sources, selling the system to physicians need only be revenue neutral to provide significant benefit to Rite Aid or the like.

If Rite Aid charges an illustrative $200.00 license fee per user (i.e., one computer with the CTW System loaded on it), per year, physicians would have a huge incentive to purchase a license and use the CTW System because they currently pay much more for their billing systems. Census data from the 2001 Service Annual Survey indicates that there are numerous offices in the United States offering ambulatory health care services. If 100,000 users licensed the CTW System annually, Rite Aid or the like could generate $20 million per year in revenue from the licenses, alone. Revenues of that magnitude should cover the cost of developing, marketing and maintaining software for the CTW System and improve Rite Aid or the like's bottom line.

In addition, when a physician contracts with Rite Aid or the like to use the CTW System, the physician becomes a business partner with Rite Aid or the like, as well, thus solidifying the relationship between Rite Aid or the like and a large pool of physicians.

9. Effective Method of Addressing Privacy Concerns

Privacy issues regarding medical information present a real concern to patients and lawmakers, as evidenced by the enactment and implementation of the Health Insurance Portability and Accountability Act (HIPAA) of 1996. The CTW System will provide patients with alternative options for the use of their information. These options will allow patients to control the use of their information, as well as provide opportunities for them to benefit from such use.

Conclusion

The CTW System affords Rite Aid or the like potential to reap enormous rewards as a result of the significant benefits to patients, physicians, pharmaceutical manufacturers and governments. Doctors will have enormous incentive to use the CTW System. By controlling the wire, Rite Aid or the like will become business partners with the doctors and the pharmaceutical manufacturers. As a result, the CTW System will add a positive dimension to Rite Aid or the like's operations, profitability and reputation and help Rite Aid or the like emerge as the undisputed leader in its industry.

Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

1. A system for the capture, management or use of patient medical and prescription data, comprising: a computer system configured for the generation of at least one form for patient medical and prescription data.

2. The system of claim 1, wherein said system is configured for the case-by-case generation of a new patient registration form.

3. The system of claim 1, wherein said system is configured for the case-by-case generation of a CTW form containing diagnoses and procedures relevant to a particular patient.

4. The system of claim 1, wherein said system is configured for the generation of a basic CTW form containing diagnoses and procedures relevant to a particular physician's practice.

5. The system of claim 1, wherein said system is configured for the case-by-case generation of a CTW form containing diagnoses and procedures relevant to a particular patient based on the patient's medical history, prescription history and present complaints.

6. The system of claim 5, wherein said system is configured for providing a list of at least one potential procedures and/or a list of at least one potential prescriptions for a complaint entered.

7. The system of claim 6, wherein said system is configured for assigning each complaint/procedure/medication unit a CPM code to facilitate reimbursements.

8. The system of claim 1, wherein said system includes a database of known drug interactions, side effects or warnings.

9. The system of claim 1, wherein said system includes a database of patient medical and prescription data for a large population of individual patients.

10. The system of claim 3, wherein the system is configured to generate a CTW form based on information provided by a patient.

11. The system of claim 10, wherein said system is configured to generate such a CTW form based on scanning of information on a physical medium.

12. The system of claim 10, wherein said system is configured to generate such a CTW form based on information electronically entered corresponding to a location on a computer image by a touch screen or graphical user interface.

13. The system of claim 1, wherein said system includes at least one server configured to create an on-line Web Site accessible to at least one physician computer executing browser software.

14. The system of claim 1, wherein said Web Site includes a plurality of sections accessible to different end users.

15. The system of claim 14, wherein said Web Site includes a physician section, a pharmaceutical entity section, and/or a patient section.

16. The system of claim 14, wherein said Web Site includes a physician section via which a physician can input information related to drugs which can be used to update information contained within a database of said system.

17. The system of claim 14, wherein said Web Site includes a patient section via which a patient can input information related to drugs which can be used to update information contained within a database of said system.

18. The system of claim 14, wherein said Web Site includes a pharmaceutical entity section via which a pharmaceutical entity can input information related to drugs which can be used to update information contained within a database of said system.

19. A system for the capture, management or use of patient medical and prescription data, comprising:
a) a computer system including at least one server computer and at least one physician computer in communication with said at least one server over a network, such as the Internet;
b) wherein said at least one server computer includes a database of drug side effects, interactions or contraindications, which are accessible via said at least one physician computer via a graphical user interface.

20. The system of claim 19, wherein said computer system is configured to provide coupons or rewards to patients based on data in said database.
